(19) United States
(12) Patent Application Publication
(10) Pub. No.: US 2011/0315788 A1
(43) Pub. Date: Dec. 29, 2011

(54) PORTABLE POWERED GARDEN SPRAYER

(76) Inventor: Jeffrey Todd HENDERSON, Cassville, MO (US)

(21) Appl. No.: 13/163,230

(22) Filed: Jun. 17, 2011

Related U.S. Application Data
(60) Provisional application No. 61/398,299, filed on Jun. 24, 2010.

(51) Int. Cl. B05B 9/08

(52) U.S. Cl. 239/152

(57) ABSTRACT

A portable powered garden sprayer. The sprayer can include a tank, a housing disposed over the tank, the housing including a handle, a filling portion in fluid communication with the tank, the filling portion extending outward from the tank past the housing and comprising a filling neck, a pump disposed within the housing, the pump being in fluid communication with the tank and with an aperture defined in the housing, a power source disposed within the housing and operatively coupled to a switch disposed on the housing and to the pump, a hose having at a first end thereof a coupling plug adapted to removably couple to the aperture, an extendible wand coupled to a second end of the hose, the wand having a gripping portion, a telescopic portion, and a nozzle, a lamp coupled to the wand, and a wand holder coupled to the housing and sized to removably receive the wand therein.

### CROSS-REFERENCE TO RELATED APPLICATIONS

This application claims priority to U.S. Provisional Patent Application No. 61/398,299, filed Jun. 24, 2010 and entitled AUTO SPRAY, the entire contents of which are hereby incorporated by reference.

### BACKGROUND

In horticulture, a need to spray liquids on the flora can occur frequently. Typically, liquid pesticides are dispersed by spraying the pesticide on the flora, in the area where the flora is growing, or directly on the unwanted pests. Additionally, for certain types of flora, it is beneficial that the plants be sprayed with water for irrigation purposes. Certain liquid fertilizers may be also dispersed by spraying the area where the flora is growing.

Sprayers for garden applications include powered sprayers and manual sprayers. Many powered sprayers draw power from an external source, and are therefore required to be plugged into an outlet, thereby limiting the possible range of travel of the sprayer. Therefore there may be portions of a garden that are out of reach of a power sprayer. Conversely, manual sprayers may be transported without restriction; however, the operation of the manual pump requires considerable and repeated effort, which may be exhausting under certain environmental conditions. Furthermore, it may be necessary to spray liquids on flora under low-light conditions, which requires the user to provide a light source along with transporting the sprayer.

A convenient, lightweight, powered garden sprayer that provides illumination in low-light conditions is therefore desired.

### SUMMARY

According to at least one exemplary embodiment, a portable powered garden sprayer is disclosed. The sprayer can include a tank, a housing disposed over the tank, the housing including a handle, a filling portion in fluid communication with the tank, the filling portion extending outward from the tank past the housing and comprising a filling neck, a pump disposed within the housing, the pump being in fluid communication with the tank and with an aperture defined in the housing, a power source disposed within the housing and operatively coupled to a switch disposed on the housing and to the pump, a hose having at a first end thereof a coupling plug adapted to removably couple to the aperture, an extendible wand coupled to a second end of the hose, the wand having a gripping portion, a telescopic portion, and a nozzle, a lamp coupled to the wand, and a wand holder coupled to the housing and sized to removably receive the wand therein.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a perspective view of an exemplary embodiment of a portable powered garden sprayer.

FIG. 2 is a partial cutaway view of an exemplary embodiment of a portable powered garden sprayer.

FIG. 3 is a side view of an exemplary embodiment of a wand for a portable powered garden sprayer.

FIG. 4a is a front view of an exemplary embodiment of a lamp for a portable powered garden sprayer.

FIG. 4b is a front view of an exemplary embodiment of a lamp mount for a portable powered garden sprayer.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

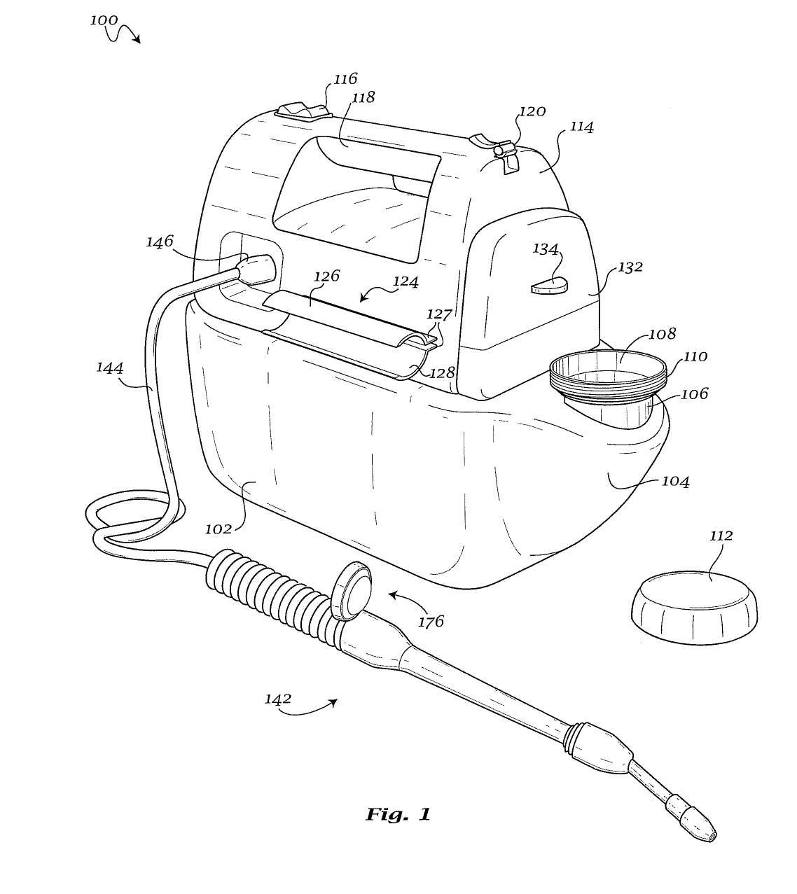

Generally referring to FIGS. 1-4b, a portable powered garden sprayer may be disclosed. The garden sprayer can include a tank for storing a liquid, which may be water, pesticide, insecticide, liquid fertilizer, ice melting liquids, or any other desired liquid or mixture of liquids, or liquid containing a water soluble substance. A housing disposed above the tank can include a pump for transferring liquid from the tank into a hose coupled to the housing. The hose can further be coupled to a telescopically extendable wand having an adjustable spray nozzle. The wand can include a lamp for illuminating the surrounding area in the direction of the nozzle. A handle and carrying strap may also be provided for ease of portability.

FIG. 1 shows an exemplary embodiment of a portable powered garden sprayer 100. Sprayer 100 can include a tank 102 wherein a liquid may be stored and a housing 114 disposed over tank 102. Tank 102 can be sized to contain approximately one gallon of liquid, although other volumes for tank 102 may be contemplated and provided as desired. Tank 102 can have any desired shape or configuration. In the exemplary embodiment, tank 102 can have a shape approximating that of a rectangular prism with rounded corners. A filling portion 104 may be provided in fluid communication with tank 102 and may be formed integral with tank 102. Filling portion 104 may be disposed at any desired location relative to tank 102. In the exemplary embodiment, filling portion 104 can be disposed substantially near the front of tank 102 and extend outward past housing 114, thereby providing clearance for a filling neck 106 having an opening 108. The clearance between filling portion 104 and housing 114 allows the user to easily pour liquids from bulky containers without interference from housing 114. Filling neck 106 may include coupling members 110 for removably coupling a cap 112 to neck 106. Coupling members 110 may be threads, tabs, grooves, or any other desired coupling member, and may engage complementary coupling members on cap 112.

Disposed substantially over tank 102 may be housing 114. In the exemplary embodiment, housing 114 may have a shape approximating that of a trapezoidal prism having rounded corners and tapering towards the top of the housing, a shape approximating a parabolic prism or any other desired shape. A user-operable power switch 116 may be disposed on the exterior of housing 114. For ease of portability, housing 114 can include a handle 118 which may be formed integral with housing 114. Housing 114 can also include attachment structures 120 for removably attaching and securing a carrying strap 122. Attachment structures 120 may be clips, snaps, bars, loops, or any other known attachment structure.

Housing 114 may further include a wand holder 124 for removably attaching a wand 142 to housing 114, for example during storage or transport of sprayer 100. Wand holder 124 may include an upper semicircular portion 126 and a lower semicircular portion 128, the inner radius between the semicircular portions being slightly greater than the radius of a portion of wand 142, for example the gripping portion 148, so as to frictionally retain wand 142 between portions 126, 128. A gap between the two portions can be substantially smaller than the radius of the same portion of wand 142, for example gripping portion 148, such that the wand may pass through the gap upon application of pressure by the user. The wand holder 124 can thus allow for ease of insertion and removal of wand 142 and for securely maintaining the wand therein. Bridging portions 127 may be disposed between housing 114 and semi-circular portions 126, 128. The bridging portions can provide a structure onto which hose 144 may be wound, thereby providing for unobtrusive storage of hose 144.

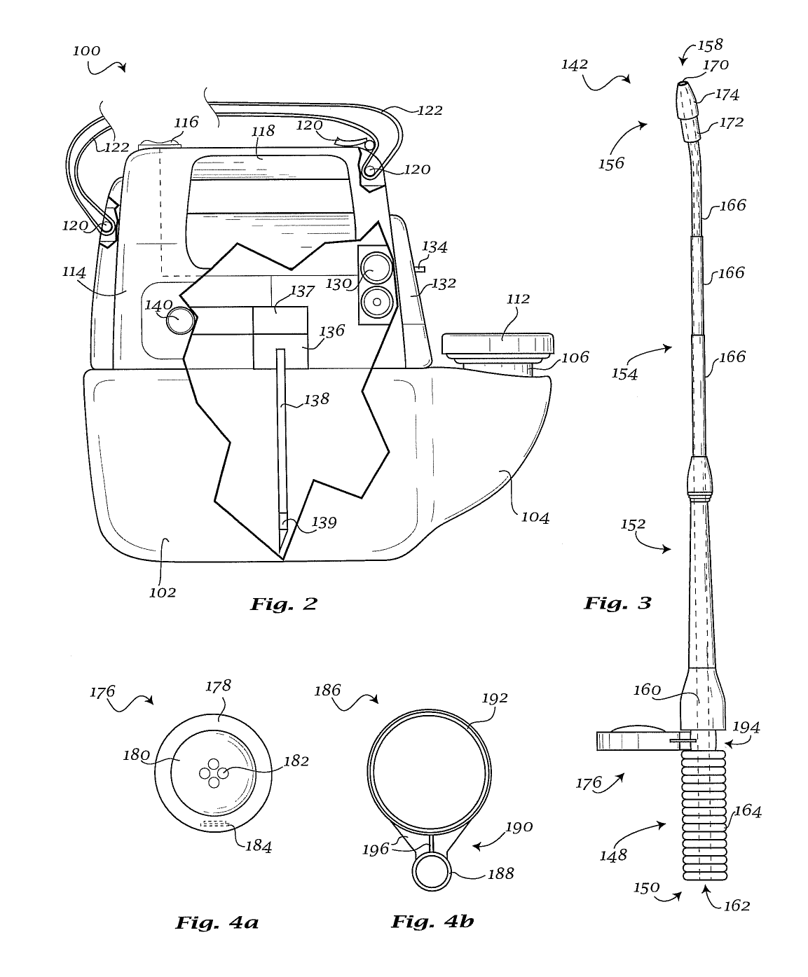

Turning to FIG. 2, disposed within housing 114 may be power source 130 and pump 136. Power source 130 may be any type of direct current power source, and may be rechargeable or non-rechargeable. In one embodiment, power source 130 may have a voltage of approximately 6 volts. For example, power source 130 may include four D-size batteries. If power source 130 is rechargeable, sprayer 100 can further include a power coupling and a rectifier, thereby allowing sprayer 100 to be connected to household alternating current source so as to recharge power source 130. A removable lid 132 may be disposed proximate to power source 130 so as to allow for easy access to and replacement of power source 130. Lid 132 can include a tab 134 disposed thereon to facilitate convenient removal of the lid.

Pump 136 may be in fluid communication with a pickup tube 138 disposed within tank 102, and with an aperture 140 defined in housing 114. Pump 136 may be, for example, a self-priming rotary pump, or may be any type of fluid pumping device known in the art that enables sprayer 100 to function as described herein. Pump 136, power source 130, and switch 116 may be operatively coupled such that switch 116 can control the supply of power to pump 130, thereby allowing the user to activate and deactivate the pump via switch 116. A sediment filter 139 may be disposed proximate the lower end of the pickup tube so as to reduce the likelihood of clogging of pump 136. A pressure regulator 137 may further be in fluid communication with pump 136, so as to facilitate delivery of the liquid at a constant pressure.

Sprayer 100 may further include a wand 142 and a flexible hose 144 coupled to wand 142. Hose 144 may include at a first end thereof a coupling plug 146 that can allow hose 144 to be removably coupled to aperture 140 of housing 114. Coupling plug 146 may be adapted for fast and simple coupling and decoupling, and may couple to aperture 140 via threads, tabs, grooves, spring-loaded or resilient members, or any other desired coupling structure. Flexible hose may have a length and a flexibility that can facilitate directing the liquid to any desired area without changing the orientation of the housing and tank of the sprayer.

Turning to FIG. 3, wand 142 may be extendible, and can include a gripping portion 148 disposed at a proximal end 150 of the wand, a fixed tube portion 152, at least one telescoping portion 154 and a nozzle 156 disposed at a distal end 158 of the wand, with each portion of wand 142 having a bore 160 defined therethrough so as to provide a conduit for the liquid from hose 144 to nozzle 156. Gripping portion 148 can include an aperture 162 at proximal end 148 as well as structures for coupling a second end of hose 144 to wand 142. Gripping portion 148 can further include structures 164 for providing a comfortable grip for a user's hand. Tube portion 152 may be disposed between handle portion 148 and telescoping portion 154 and may taper towards the telescoping portion.

Telescoping portion 154 may include a plurality of telescoping members 166 disposed in telescoping relation with each other and sized such that a friction fit exists between the members so as to maintain telescoping portion 154 at a desired length during operation of sprayer 100. The telescoping member most proximate to the distal end 158 of wand 142 may include a bend 168 in a portion thereof. The bend 168 can facilitate directing the liquid at an angle to the longitudinal axis of wand 142. This can allow the user to hold the wand more comfortably; for example, in the case of small ground flora, the wand may be held substantially horizontally, while the liquid can be directed downwards substantially toward the ground and the small flora. In the exemplary embodiment, when telescoping portion 154 is fully extended, the length of wand 142 may be approximately 24 inches, although other lengths for wand 142 may be contemplated and provided as desired.

Nozzle 156 can be disposed at distal end 158 of wand 142 and can include an aperture 170 sized and configured to generate a desired spray pattern, for example a solid cone spray pattern, a flat-fan spray pattern, an even-flat-fan spray pattern, or any other spray pattern known in the art. Nozzle 156 may further be adjustable so as to facilitate varying the area or type of the spray pattern from aperture 170. In the exemplary embodiment, nozzle 156 can include a fixed portion 172 and a movable portion 174. Moveable portion 174 may be moved longitudinally relative to fixed portion 172, for example by being rotated or translated by the user, which can in turn vary the area or type of the spray pattern from aperture 170.

A lamp 176 may be provided on wand 142. As shown in FIG. 4a, lamp 176 can include a lamp housing 178, a lens 180, and a light source 182. The light source may be any desired light source, for example, one or more light-emitting diodes, or an incandescent bulb. The emitted light may be focused by lens 180, or by a reflective surface included in lamp housing 178. Lamp housing 178 may have any desired shape, for example a circular, oval, rectangular or square shape.

Lamp 176 may further include a power source 184 which may be, for example, a battery, and be disposed within lamp housing 178, or may be electrically coupled to power source 130 disposed in housing 114. The operation of lamp 176 may be selectively controlled by the user, or may be coupled to the operation of sprayer 100 such that lamp 176 is illuminated when sprayer 100 is operational.

Lamp 176 may be coupled to wand 142 by use of a lamp mount 186. As shown in FIG. 4b, lamp mount 186 may include a wand receiving portion 188, a stem 190, and a lamp receiving portion 192. Wand receiving portion 188 may be sized to receive a portion of wand 142 therethrough such that lamp mount 185 is maintained in a fixed position due to friction between wand receiving portion 188 and the wand. In some embodiments, wand 142 may include a portion 194 sized to be received within wand receiving portion 188. Lamp receiving portion 192 may be sized and shaped to receive lamp housing 178 therein such that lamp 176 is maintained in a fixed position due to friction between wand receiving portion 192 and lamp housing 178. Stem 190 may extend between the wand receiving portion and the lamp receiving portion of the mount, and may be reinforced, for example, by orthogonally positioned members 196.

The above-described components of sprayer 100 may be formed from any desired material, for example, polymer-based materials such as injection-molded ABS plastic, or any suitable metal or alloy that enables sprayer 100 to function as described herein.

In operation, the user can fill tank 102 with a desired liquid and close off filling neck 106 with cap 112. The user can then move switch 116 to the operational position, providing pump 136 with current from power source 130. Pump 136 can then draw liquid in from tank 102 via pickup tube 138 and direct the liquid to aperture 140. Pressure regulator 137, if present, can provide a substantially constant liquid pressure output to aperture 140. The user can then spray the liquid on any desired area, and may illuminate the area with lamp 176. If the user decides to change the type of liquid being sprayed, sprayer 100 may be flushed by pouring a hot soap solution into tank 102 and operating the sprayer so that the soap solution is sprayed through aperture 140.

The portable powered garden sprayer disclosed herein can provide a lightweight, low-cost, and easily transportable solution for spraying liquid on a desired object from a distance. The garden sprayer allows the user to spray liquid without manual exertion and without being tethered to an external power source. The garden sprayer also provides illumination of the area being sprayed, allowing the sprayer to be used in low-light or no-light conditions.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A portable powered garden sprayer, comprising:
a tank;
a housing disposed over the tank, the housing comprising a handle;
a filling portion in fluid communication with the tank, the filling portion extending outward from the tank past the housing and comprising a filling neck;
a pump disposed within the housing, the pump being in fluid communication with the tank and with an aperture defined in the housing;
a power source disposed within the housing and operatively coupled to a switch disposed on the housing and to the pump;
a flexible hose having at a first end thereof a coupling plug adapted to removably couple to the aperture;
an extendible wand coupled to a second end of the hose, the wand comprising a gripping portion; a telescopic portion, and a nozzle;
a lamp coupled to the wand; and
a wand holder coupled to the housing and sized to removably receive the wand therein.

2. The sprayer of claim 1, further comprising a pickup tube extending from the pump to the tank, and being in fluid communication with the tank and the pump.

3. The sprayer of claim 2, further comprising a sediment filter disposed in the pickup tube.

4. The sprayer of claim 1, wherein the pump is a self-priming rotary pump.

5. The sprayer of claim 1, further comprising a pressure regulator in fluid communication with the pump.

6. The sprayer of claim 1, further comprising:
a carrying strap;
attachment structures for removably attaching the carrying strap, the attachment structures being coupled to the housing.

7. The sprayer of claim 1, wherein the handle is formed integral with the housing.

8. The sprayer of claim 1, wherein the tank is sized to hold approximately one gallon of liquid.

9. The sprayer of claim 1, wherein the extendible wand has a length of approximately 24 inches when the wand is fully extended.

10. The sprayer of claim 1, wherein the nozzle has one or both of a variable spray pattern and a variable spray area.

11. The sprayer of claim 1, wherein the wand has a bend.

12. The sprayer of claim 1, wherein the power source is rechargeable.

13. The sprayer of claim 1, wherein the power source comprises at least one battery.
